(19) United States
(12) Patent Application Publication
(10) Pub. No.: US 2021/0017634 A1
(43) Pub. Date: Jan. 21, 2021

(54) Steel For Monolithic And Bimetallic Band Saws For Wood

(71) Applicant: QSGS Technology Gra?yna Klepuszewska, Ostroleka (PL)

(72) Inventors: Jan Klepuszewski, Ostro??ka (PL); Piotr Ba?a, Ostro??ka (PL)

(21) Appl. No.: 17/043,046

(22) PCT Filed: Apr. 3, 2019
(86) PCT No.: PCT/PL2019/050020

§ 371 Date: Sep. 29, 2020

(30) Foreign Application Priority Data
Apr. 11, 2018 (PL) P.425197

(51) Int. Cl. C22C 38/48; C22C 38/44; C22C 38/00; C22C 38/04; C22C 38/02; C21D 9/24; B23D 61/12

(52) U.S. Cl. CPC C22C 38/48; C22C 38/44; C22C 38/001; B23D 61/127; C22C 38/04; C22C 38/02; C21D 9/24; C22C 38/002

(57) ABSTRACT

Exemplary embodiments relate to a steel composition for monolithic and bimetallic band saw blades including a band, intended for heat treatment in a continuous manner. The steel composition for a band saw blade including a band comprising manganese, nickel, silicone, carbon, chromium, molybdenum, niobium, sulfur, phosphorus, and iron.

### TECHNICAL FIELD

Exemplary embodiments relate to a new steel grade intended for monolithic and bimetallic woodworking band saw blades including a band.

### BACKGROUND

A band saw is a tool intended basically for cold operation, but the specifics of the work, i.e. cutting various types of materials, wood in particular, and in various conditions, may result in its localised heating to high temperatures. Examples of band saws, band saw blades including a band, and saw bands are shown in U.S. Pat. No. 2,549,384, which is incorporated herein by reference in its entirety, as well as in U.S. Pat. 3,593,600, which is incorporated herein by reference in its entirety.

Apart from a possible temperature rise, band saws are subject to cyclic changing loads, resulting in fatigue cracking. The band saw itself is a closed-loop band, tensioned between two or three pulleys, one of which is driven. The monolithic bands are those made wholly of a single material. The bimetallic bands essentially consist of the carrier band and the blades, made of various materials, in order to utilise their different properties, such as fatigue strength or cutting properties. Therefore, alloy steel grades are used for band saws, and one of the most important properties is their adequate micro-structure.

Band saw blades including a band and steel for band saws blades including bands may benefit from improvements.

### SUMMARY

Exemplary embodiments provide a tool steel for monolithic and bimetallic band saw blades including a band that is lower-alloyed than those commonly used, and which is free of the prior art deficiencies.

Thus, the exemplary embodiments provide a tool steel, lower-alloyed than those commonly used, intended for band saw blades including a band, featuring a fine-grain microstructure, high hardening ability, high hardness, good fatigue strength and which is, simultaneously, suitable for both cold and hot operation, at high temperature variability during localised heating during operation.

Therefore, an exemplary new chemical composition of steel dedicated for monolithic or bimetallic band saws is proposed, with adequate contents of chromium, nickel and molybdenum, as well as with a niobium addition, that overcomes the problems of the prior art.

Thus, the exemplary embodiments relate to a new chemical composition of steel for monolithic and bimetallic band saw blades including a band. The exemplary steel, according to the exemplary embodiments for monolithic and bimetallic band saws, intended for heat-treatment in a continuous manner, comprises, by weight, from 0.50 to 0.75% manganese, from 0.4 to 0.8% nickel, from 0.1 to 0.4% silicone, from 0.48 to 0.53% carbon, from 1.10 to 1.40% chromium, from 0.25 to 0.40% molybdenum, from 0.10 to 0.15% niobium, and sulphur and phosphorus both less than 0.02% by weight each, wherein the rest is iron and unavoidable impurities.

In exemplary embodiments, the exemplary steel comprises, by weight, 0.51% carbon, 1.3% chromium, 0.7% manganese, 0.15% silicon, 0.52% nickel, 0.36% molybdenum, 0.12% niobium, 0.008% sulphur and 0.010% phosphorus.

In alternative exemplary embodiments, the exemplary steel comprises, by weight, 0.49% carbon, 1.21% chromium, 0.76% manganese, 0.18% silicon, 0.45% nickel, 0.31% molybdenum, 0.11% niobium, 0.005% sulphur and 0.011% phosphorus.

In alternative exemplary embodiments, the exemplary steel comprises, by weight, 0.51% carbon, 1.38% chromium, 0.66% manganese, 0.31% silicon, 0.78% nickel, 0.29% molybdenum, 0.15% niobium, 0.005% sulphur and 0.010% phosphorus.

However, these examples of a new composition of steel for monolithic and bimetallic band saw blades including a band are merely exemplary, and in other exemplary embodiments, other compositions may be used, as will be made apparent from the following detailed description.

### DETAILED DESCRIPTION

In order to provide adequate cutting properties and fatigue strength, the microstructure of a band saw must feature a fine-grain former austenite (minimum 9, preferably 11-12) and must be composed of high-tempered martensite, without primary and secondary precipitations of carbides.

Alloy steel grades for monolithic and bimetallic woodworking band saws include low carbon alloy steel that is intended for bimetallic bands as the carrier band. Due to the chemical compositions of low carbon alloy steels, among other properties, low carbon alloy steels are expensive alloy steel grades, and it is not possible to obtain good cutting properties by using them, because of the low carbon content.

Higher carbon steel alloys are expensive grades as well. These steels feature better cutting properties, but are simultaneously characterised by higher coarsening propensities during austenitising for hardening.

Both of the above-mentioned grades, considering their complex chemical composition, require a high temperature of austenitising for hardening (1070÷1120° C.) during heat treatment.

Other steels, that are essentially spring steels, used for band saws, feature low hardening-susceptibility, i.e. the ability of obtaining a martensitic microstructure. The presence of vanadium in the chemical composition of these other steels helps against austenite grain coarsening during austenitisation for hardening. In conventional heat-treatment furnaces and the application of long austenitising times, the vanadium properly serves its function, but on the production lines for continuous heat-treatment, as is the case of band saws, the time of austenitising is short; therefore, the time of treatment is compensated for with a substantially increased temperature of steel austenitising, which results in very difficult control of the austenite grain in band saws made of these other steels. The composition of these other steels results in the dissolution of all carbides failing, which is necessary for saturating the metallic matrix with alloy elements and carbon, or the steel is overheated and high austenite grain coarsening follows, which results in a poorer fatigue strength of the steel.

Niobium is a commonly used component of structural steels, featuring fine-grains and increased mechanical properties. However, until the exemplary embodiments disclosed herein, niobium has not been used in tool steels for band saws. As the micro-additive in structural steel, niobium effectively enables grain coarsening inhibition by precipitation of NbC carbides during thermo-mechanical processing. The steels, however, are not heat-treated by hardening and high-tempering. As an alloy additive, it is also used mostly for reducing intercrystalline corrosion of austenitic steels, particularly the welded members made of this steel. The niobium bonds whole carbon in the form of NbC, but it is usually added in high excess, e.g. in an amount of 10×% C. Furthermore, the addition of niobium to high-temperature creep resistant steels also results in precipitation hardening by intermetallic compounds or by NbC. The niobium dissolved in a solid solution increases the steel hardening capability and substantially improves the mechanical properties at increased temperatures. Obtaining such steel characteristics requires, however, solutionising or austenitising at temperatures exceeding 1200° C.

As previously discussed, up to the present, niobium was rarely used in tool steels (e.g. the steel for fatigue-loaded parts PL225572 and alloy tool steel PL227829 do not comprise niobium additives). Band saws made of niobium-comprising steels have not been produced, either. For the tool materials, such as intended for woodworking saws, which are required to have a high fatigue strength, incorrectly selected niobium contents may result in lowering of the fatigue strength and other mechanical properties, hardness for example.

It has been found that the presence of chromium, manganese, molybdenum and nickel in adequate amounts, provide high hardenability of the new steel, together with an adequate carbon content, enables one to obtain a high hardness and excellent mechanical properties. The addition of niobium to the exemplary composition prevents grain coarsening, therefore, the exemplary steel gains good fatigue properties. Furthermore, this addition is selected such that it does not result in lowering the fatigue strength and other mechanical properties, e.g. hardness.

The exemplary new chemical composition of the steel for monolithic and bimetallic band saw blades including a band is particularly intended for heat treatment in a continuous manner, where rapid heating ˜50÷1000° C./s of the batch, a high austenitising temperature (50-100° C. higher than that used in conventional heat treatment) and short austenitising times (depending on furnace length and belt travel speed, no longer than 120 seconds) are applied. Owing to the unique exemplary chemical composition, the exemplary new steel is not prone to strong grain coarsening, therefore, very good fatigue strength is obtained, simultaneously with good cutting and mechanical properties. This has a direct economical effect, resulting from the resignation from expensive alloy steel grades and using a lower austenitising temperature for hardening (lower than for higher-alloyed steels) and tempering (lower than for higher-alloyed steels).

Furthermore, the exemplary chemical composition of the exemplary new steel results in inhibiting austenite grain coarsening by NbC precipitations during inductive heating of monolithic saw teeth and austenitising in conveyor furnaces in lines for continuous treatment of saws. In the induction hardening process of teeth, as well as in conveyor furnaces in lines for continuous treatment of saws, one has to deal with austenitising temperatures higher than those recommended, which in other grades, results in grain coarsening. The new exemplary grade, following hardening within a 950÷1000° C. range (60-120 s austenitising time), has the grain of former austenite within the 10-12 class range according to ATSM. Furthermore, the addition of molybdenum in the amount specified above prevents II^{nd} type temper brittleness.

Additionally, the exemplary new steel grade, considering the lower Ce carbon equivalent, facilitates laser welding of flat wire from high-speed steel with the ridge of the saw carrier band (made of the exemplary new steel grade) in bimetallic saws and results in higher joint strength, and also facilitates welding of sintered carbides to the tips of the teeth in carbide saws, providing a higher strength of the joint.

The contents of Mn in the composition of the exemplary steel may amount, as indicated above, to 0.5-0.75% by weight. All values of Mn contents, within the range of 0.5-0.75% by weight, may be included in the exemplary embodiments. For example, exemplary embodiments may include, but are not limited to, the Mn contents in the exemplary composition of the steel in amounts such as 0.5-0.7% by weight, 0.5-0.66% by weight, 0.66-0.75% by weight, 0.66-0.70% by weight, or 0.7-0.75% by weight.

The contents of Ni in the composition of the exemplary steel may amount, as indicated above, to 0.4-0.8% by weight. All the values of Ni contents within the range of 0.4-0.8% by weight, may be included in the exemplary embodiments. For example, exemplary embodiments may include, but are not limited to, the content of Ni in the exemplary steel composition in amounts such as 0.4-0.78% by weight, 0.4-0.52% by weight, 0.4-0.45% by weight, 0.45-0.8% by weight, 0.45-0.78% by weight, 0.45-0.52% by weight, 0.52-0.8% by weight, 0.52-0.78% by weight, or 0.78-0.8% by weight.

The contents of Si in the composition of the exemplary steel may amount, as indicated above, to 0.10-0.40% by weight. All the values of Si contents in the exemplary steel composition, within the range of 0.10%-0.40%, may be included in the exemplary embodiments. For example, exemplary embodiments may include, but are not limited to, the content of Si in the exemplary steel composition in amounts such as 0.10-0.31% by weight, 0.10-0.18% by weight, 0.10-0.15% by weight, 0.15-0.40% by weight, 0.15-0.31% by weight, 0.15-0.18% by weight, 0.18-0.40% by weight, 0.18-0.31% by weight, or 0.31-0.40% by weight.

The contents of C in the exemplary composition of the steel may amount, as indicated above, to 0.48-0.53% by weight. All the values of C contents in the exemplary steel composition, within the range of 0.48-0.53%, may be included in the exemplary embodiments. For example, the exemplary embodiments may include, but are not limited to, the content of C in the exemplary steel composition in amounts such as 0.48-0.51% by weight, 0.48-0.49% by weight, 0.49-0.53% by weight, 0.49-0.51% by weight, or 0.51-0.53% by weight.

The contents of Cr in the exemplary composition of the steel may amount, as indicated above, to 1.10-1.40% by weight. All the values of Cr contents in the exemplary steel composition, within the range of 1.10-1.40%, may be included in the exemplary embodiments. For example, the exemplary embodiments may include, but are not limited to, the content of Cr in the exemplary steel composition in amounts such as 1.10-1.38% by weight, 1.10-1.30% by weight, 1.10-1.21% by weight, 1.21-1.40% by weight, 1.21-1.38% by weight, 1.21-1.30% by weight, 1.30-1.40% by weight, 1.30-1.38% by weight, or 1.38-1.40% by weight.

The contents of Mo in the exemplary composition of the steel may amount, as indicated above, to 0.25-0.40% by weight. All the values of Mo contents in the exemplary steel composition, within the range of 0.25-0.40%, may be included in the exemplary embodiments. For example, the exemplary embodiments may include, but are not limited to, the content of Mo in the exemplary steel composition in amounts such as 0.25-0.36% by weight, 0.25-0.31% by weight, 0.25-0.29% by weight, 0.29-0.40% by weight, 0.29-0.36% by weight, 0.29-0.31% by weight, 0.31-0.40% by weight, 0.31-0.36% by weight, or 0.36-0.40% by weight.

The contents of Nb in the exemplary composition of the steel may amount, as indicated above, to 0.10-0.15% by weight. All the values of Nb contents, within the range of 0.10-0.15%, may be included in the exemplary embodiments. For example, the exemplary embodiments may include, but are not limited to, the content of Nb in the exemplary steel composition in amounts such as 0.10-0.12% by weight, 0.10-0.11% by weight, 0.11-0.15% by weight, 0.11-0.12% by weight, or 0.12-0.15% by weight.

The amounts of both P and S in the exemplary steel composition, according to the exemplary embodiments, should not exceed 0.02% by weight.

According to the exemplary embodiments, combinations of all the above-indicated exemplary amounts of elements, comprised in the exemplary steel composition, within the above specified ranges, may be included in alternative exemplary embodiments of the exemplary steel composition.

The exemplary embodiments are further presented in a non-limiting manner in the following examples of exemplary embodiments. The exemplary steel, according to the following examples of exemplary embodiments, may be obtained with melt techniques known to persons skilled in the art, i.e. by melting in an arc furnace or any other melt technique known to persons skilled in the art. The exemplary composition of the steel can also be determined with measuring techniques known to persons skilled in the art, e.g. with a spark spectrometer, or any other measuring technique known to persons skilled in the art.

### EXAMPLE 1

In an exemplary embodiment, the exemplary alloy steel intended for monolithic and bimetallic band saw blades including a band comprises: 0.51% C; 1.3% Cr; 0.7% Mn; 0.15% Si; 0.52% Ni; 0.36% Mo; 0.12% Nb; 0.008% S; 0.010% P, wherein the rest is iron and unavoidable impurities. Following hardening and tempering down to approximately 470 HV10 (˜47 HRC) hardness, the tensile strength obtained for bands was 1510 MPa on average, with a 1465 MPa yield point and A80 elongation equal to 8%. Following hardening within a 950÷1000° C. range (60-120 s austenitising time), a grain of former austenite of 11 class according to ATSM was obtained.

### EXAMPLE 2

In an alternative exemplary embodiment, the exemplary alloy steel intended for monolithic and bimetallic band saw blades including a band comprises: 0.49% C; 1.21% Cr; 0.75% Mn; 0.18% Si; 0.45% Ni; 0.31% Mo; 0.11% Nb; 0.005% S; 0.011% P, wherein the rest is iron and unavoidable impurities. Following hardening and tempering down to approximately 470 HV10 (˜47 HRC) hardness, the tensile strength obtained for bands was 1490 MPa on average, with a 1450 MPa yield point and A80 elongation equal to 8.5%. Following hardening within a 950÷1000° C. range (60-120 s austenitising time), the grain of former austenite of 10-11 class according to ATSM was obtained.

### EXAMPLE 3

In an alternative exemplary embodiment, the exemplary alloy steel intended for monolithic and bimetallic band saw blades including a band comprises: 0.51% C; 1.38% Cr; 0.667% Mn; 0.31% Si; 0.78% Ni; 0.29% Mo; 0.15% Nb; 0.005% S; 0.011% P, wherein the rest is iron and unavoidable impurities. Following hardening and tempering down to approximately 470 HV10 (˜47 HRC) hardness, the tensile strength obtained for bands was 1520 MPa on average, with a 1470 MPa yield point and A80 elongation equal to 7.8%. Following hardening within a 950÷1000° C. range (60-120 s austenitising time), the grain of former austenite of 11-12 class according to ATSM was obtained.

Of course, these described embodiments are exemplary and alterations thereto are possible by those having skill in the relevant art and technology.

Thus, the exemplary embodiments and arrangements achieve improved capabilities, eliminate difficulties and problems encountered in the use of the prior art articles and compositions, and attain the desirable results described herein.

In the foregoing description, certain terms have been used for brevity, clarity, and understanding. However, no unnecessary limitations are to be implied therefrom because such terms are used for descriptive purposes only, and are intended to be broadly construed.

Moreover, the descriptions and exemplary compositions herein are by way of example only, and the exemplary embodiments are not limited to the features and embodiments described herein.

Further, it should be understood that elements, compositions, materials, components, and features and/or relationships associated with one embodiment can be combined with elements, compositions, materials, components, and features and/or relationships from other embodiments. That is, various elements, compositions, materials, components, and features and/or relationships from various embodiments can be combined in further embodiments. Thus, the scope of the disclosure is not limited to only the embodiments described herein.

Having described the features, compositions, discoveries, and principles of the exemplary embodiments, the manner in which they are made, utilized, and carried out, and the advantages and useful results attained, the new and useful compositions, articles, arrangements, combinations, methodologies, structures, devices, elements, combinations, operations, processes, and relationships are set forth in the appended claims.

1. (canceled)

2. (canceled)

3. (canceled)

4. (canceled)

5. An article comprising:
a monolithic or bimetallic band saw blade including a band comprised of heat-treated steel, the steel comprising,
by weight,
from 0.50% to 0.75% manganese,
from 0.4% to 0.8% nickel,
from 0.1% to 0.4% silicone,
from 0.48% to 0.53% carbon,
from 1.10% to 1.40% chromium,
from 0.25% to 0.40% molybdenum,
from 0.10% to 0.15% niobium,
less than 0.02% sulphur, and
less than 0.02% phosphorus,
wherein the remainder weight is comprised of iron and unavoidable impurities.

6. The article according to claim 5, comprising,
by weight,
0.51% carbon,
1.3% chromium,
0.7% manganese,
0.15% silicone,
0.52% nickel,
0.36% molybdenum,
0.12% niobium,
0.008% sulphur, and
0.010% phosphorus.

7. The article according to claim 5, comprising,
by weight,
0.49% carbon,
1.21% chromium,
0.76% manganese,
0.18% silicone,
0.45% nickel,
0.31% molybdenum,
0.11% niobium,
0.005% sulphur, and
0.011% phosphorus.

8. The article according to claim 5, comprising,
by weight,
0.51% carbon,
1.38% chromium,
0.66% manganese,
0.31% silicone,
0.78% nickel,
0.29% molybdenum,
0.15% niobium,
0.005% sulphur, and
0.010% phosphorus.

9. An article comprising:
a monolithic or bimetallic band saw blade including a band comprised of heat-treated steel, the steel comprising,
manganese,
nickel,
silicone,
carbon,
chromium,
molybdenum, and
niobium.

10. The article according to claim 9, comprising,
by weight, from 1.10% to 1.40% chromium.

11. The article according to claim 10, comprising,
by weight, from 0.50% to 0.75% manganese.

12. The article according to claim 11, comprising,
by weight, from 0.10% to 0.15% niobium.

13. The article according to claim 12, comprising,
by weight, from 0.25% to 0.40% molybdenum.

14. The article according to claim 13, comprising,
by weight, from 0.4% to 0.8% nickel.

15. The article according to claim 14, comprising,
by weight, from 0.1% to 0.4% silicone.

16. The article according to claim 15, comprising,
by weight, from 0.48% to 0.53% carbon.

17. The article according to claim 16, further comprising,
by weight, less than 0.02% sulphur.

18. The article according to claim 17, further comprising,
by weight, less than 0.02% phosphorus.

19. The article according to claim 18, further comprising
iron and unavoidable impurities.

20. The article according to claim 10, comprising,
by weight, from 0.10% to 0.15% niobium.

21. The article according to claim 20, comprising,
by weight, from 0.48% to 0.53% carbon.
